(19) United States
(12) Patent Application Publication
(10) Pub. No.: US 2017/0300994 A1
(43) Pub. Date: Oct. 19, 2017

(54) SERENDIPITY RECOMMENDER SYSTEM

(71) Applicant: Microsoft Technology Licensing, LLC., Redmond, WA (US)

(72) Inventors: Gal Lavee, Tel Aviv (IL); Daniel Sitton, Tel Aviv (IL); Nir Nice, Kfar Veradim (IL); Noam Koenigstein, Ra'anana (IL); Ilona Kifer, Lehavot Haviva (IL); Shahar Keren, Hemed (IL); Zohar Yakhini, Ramat Hasharon (IL)

(21) Appl. No.: 15/098,366

(22) Filed: Apr. 14, 2016

(51) Int. Cl. G06Q 30/06

(52) U.S. Cl. CPC G06Q 30/0631; G06Q 30/0603

(57) ABSTRACT

Embodiments of the disclosure relate to apparatus for recommending items from a catalog of items to users in a population of users, configured to determine values for a measure of association between transactions of users with items in a first catalog and transactions of users with items in a second catalog and provide recommendations to users for transacting with items in the catalogs based on the determined values of association.

### TECHNICAL FIELD

Embodiments of the invention relate to methods of recommending items for use.

### BACKGROUND

Modern communication networks, such as mobile phone networks and the Internet, and the plethora of devices that provide access to services that they provide have inundated people with a surfeit of information and options for satisfying any from the simplest to the most complex needs and desires. Whereas in the not too distant past, information available to an individual was relatively sparse and generally expensive in time and/or resources to acquire, today, information is relatively inexpensive. All too often, the information is overwhelmingly abundant and diluted with irrelevant information. Whereas, the cost of acquiring information has plummeted, managing its copiousness to determine its relevance has become an increasingly complex and expensive task.

Various recommender systems and algorithms have been developed to attempt to deal with the challenges and opportunities that the abundance of inexpensive information has generated, and to automatically focus and filter information in order to recommend items for a user's consumption or use that match the user's interests and needs. The recommender systems typically process data acquired for a population of users to determine characteristics of the users and their consumer histories that may be used to infer user preferences for various items comprised in a catalog of items. Generally, processing the data, involves constructing a user-item model that generates representations for users in the population and items in the catalog, and provides rules for relating the representations that relate the users to the items. Applying the rules to relate the representation of a given user to representations of items in the catalog identifies catalog items for recommendation to the user.

An amount of data gathered and processed to construct a user-item model that may be used to recommend items to a user can be very large and may for example, involve processing data indicative of preferences for tens of millions of users, for each of thousands of items. In practice, a computer having large processing resources is generally required to process the data and construct the user-item model. Often the model is not scalable.

### SUMMARY

An aspect of an embodiment of the invention, relates to providing a recommender system comprising, or having access to, a database of transactions engaged in by users with items in a first catalog of items and transactions engaged in by users with items in a second catalog of items. The recommender system, optionally referred to as a direct association (DAS) recommender system, comprises a processor configured to process data in the database to determine values for a measure of statistical association between user transactions with items in the first catalog and user transactions with items in the second catalog. The DAS recommender system recommends items from the first catalog to a user who has engaged in a transaction with a given item in the second catalog based on degree to which the measures of statistical association determined by the processor indicate that transactions with the items in the first catalog exhibit enhanced statistical association with user transactions with the given item in the second catalog. A user transaction with a catalog item may refer to any use of the catalog item by a user, and includes by way of example, such transactions as purchasing, renting, borrowing, or using the catalog item for a purpose for which it is intended or may be adapted.

In an embodiment sufficient data for determining values for the measures of statistical association may not be available, and the processor may be configured to compensate for unavailable data by generating “replacement data” based on data available in the database. Optionally, the database comprises time resolved transaction data which the processor uses to generate replacement data. In an embodiment, time resolved transaction data may comprise a date and optionally a time at which at least one transaction engaged in by a user with an item in a catalog was transacted. Optionally the time resolved transaction data comprises ordinal data indicates whether the transaction is the user's 1st, 2nd, 3rd . . . n-th, transaction. In an embodiment, a measure of associations between transactions with catalogue items is provided by determinations of values for a Lift function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1 schematically shows a DAS recommender system recommending items for purchase to users, in accordance with an embodiment of the disclosure;

FIG. 2 shows a simplified flow diagram of a procedure by which the DAS recommender systems shown in FIG. 1 provides a user with a recommendation, in accordance with an embodiment of the disclosure; and

FIGS. 3A-3C show a procedure by which the recommender system shown in in FIG. 1 may determine a degree of statistical association between items for use in providing recommendations to uses, in accordance with an embodiment of the disclosure.

### DETAILED DESCRIPTION

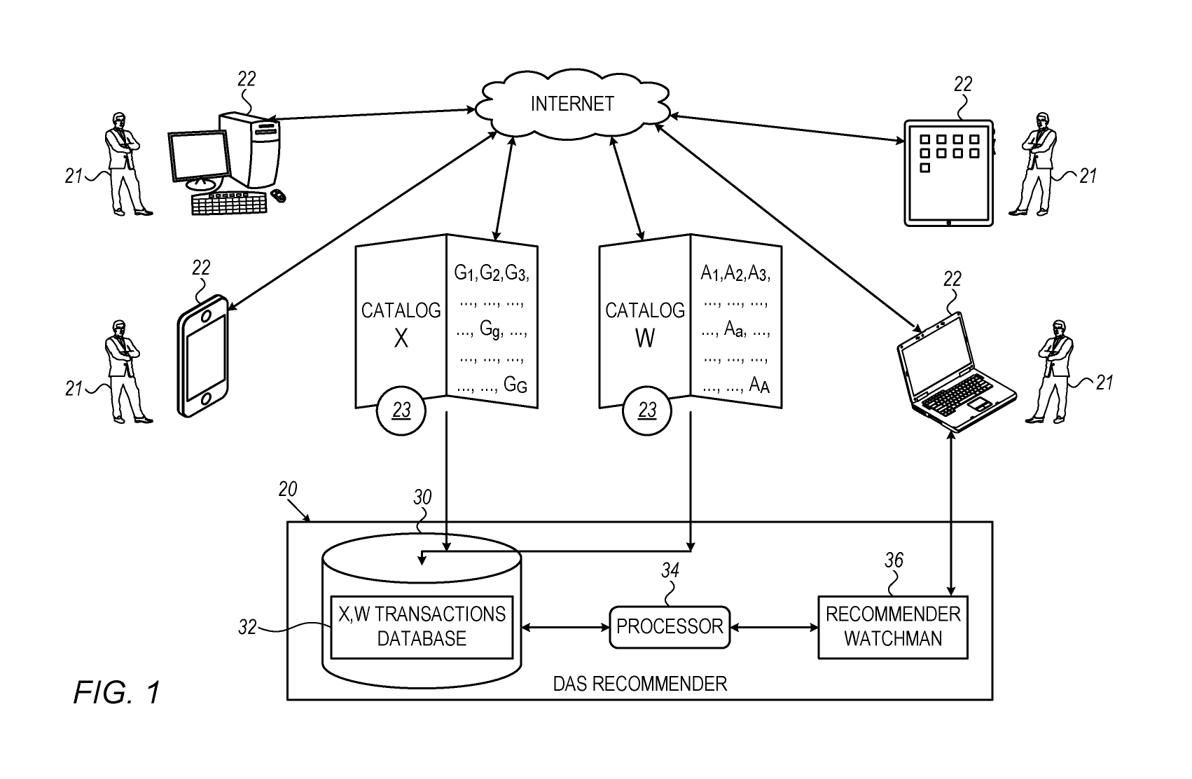

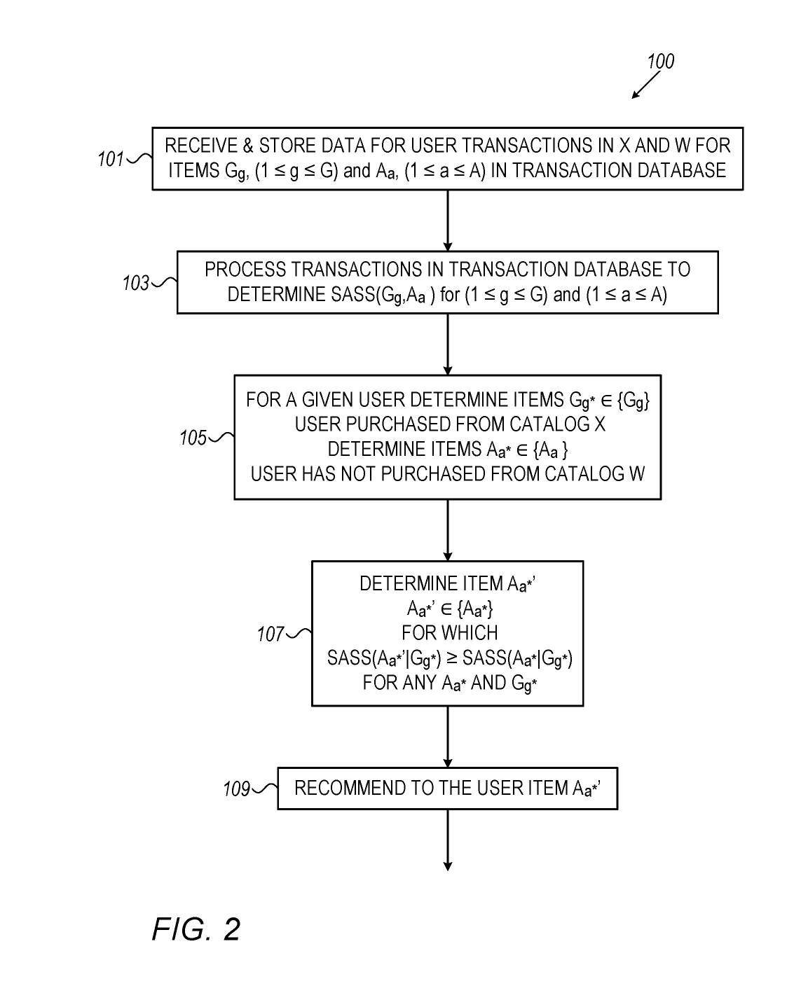

In the detailed description below a configuration of a DAS recommender system in accordance with an embodiment of the disclosure is discussed with reference to FIG. 1. FIG. 2 shows a simplified flow chart illustrating operation of the DAS recommender system shown in FIG. 1. FIGS. 2A-2D show a detailed flow chart illustrating operation of the DAS recommender system in determining statistical associations between user transactions with items provided to the users in two catalogs.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins.

FIG. 1 schematically shows a DAS recommender system 20 in accordance with an embodiment of the disclosure operating to provide recommendations to users 21 who transact with items provided in, by way of example, two catalogs “X” and “W”. For simplicity of presentation it is assumed that catalogs X and W respectively offer items G_{g} (1≦g≦G) and Aₐ (1≦a≦A) for sale, and that user transactions with the items include purchases. In an embodiment, items Aₐ in catalog W and items G_{g} in catalog X may appear to have little in common and be unrelated. By way of example, catalog X may be an online catalog of Xbox games provided by Microsoft's online Xbox store and W may be an online catalog of applications offered by Microsoft's online Windows store. User transactions may be purchases of items offered in the catalogs. For the examples of Xbox and Windows catalogs, purchases may be identified with installations of games and apps offered by the catalogs.

Users 21 may access and/or be accessed by catalog W, catalog A, and/or DAS recommender system 20 using any of various stationary or mobile communication devices, such as by way of example, a smartphone, laptop, notebook, or desktop computer. A numeral 22 labels the communication devices in FIG. 1. Access to DAS recommender system 20 may be via any suitable communication network to which t communication devices 22 may connect, such as the Internet, a mobile phone network, or local area network (LAN). For convenience of presentation, communication devices 22 are schematically shown communicating with recommender system 20 via the Internet. A user 21 may be any person who accesses, shops, and/or makes purchases from catalog X and/or from catalog W and/or accesses DAS recommender system 20 or is accessed by the recommender system.

DAS recommender system 20 in accordance with an embodiment of the disclosure may comprise a memory device 30 having stored therein a transactions database 32, a processor 34, and a “recommender watchman” 36. DAS recommender system 20 receives and stores in transactions database 32 transactions data characterizing purchases made by users 21 of items G_{g} from catalog X and purchases made by users 21 of items Aₐ from catalog W. Data characterizing a purchase transaction, also referred to as a purchase, that a user 21 makes may comprise data identifying the user, the item from catalog X or catalog W that the user purchased, and time resolution data. Time resolution data for a purchase may comprise data indicating a time at which the purchase was made and/or data indicating whether the purchase is the user's 1st, 2nd, 3rd . . . n-th, purchase of an item in catalog X or catalog W. Memory 30 may be a centralized or distributed memory. The memory may comprise or have access to any electronic and/or optical circuitry suitable for storing data and/or computer executable instructions. Memory 30 may, by way of example, comprise and/or have access to any one or any combination of more than one of a flash memory, random access memory (RAM), read only memory (ROM), and/or erasable programmable read-only memory (EPROM). DAS recommender system 20 may comprise catalog X and/or catalog W, or may be comprised in catalog X and/or catalog W. DAS recommender system 20 may communicate with catalogs X and W and/or with administrators of catalogs X and W to receive transactions data via any suitable wireless or wire communications channel.

Processor 34 is configured to process transactions data in transactions database 32 to provide values of statistical association, which may be referred to as values for SASS or simply SASS, that provide statistical indications for how strongly purchases by users 21 of items G_{g} from catalog X are associated with purchases by users 21 of items Aₐ from catalog W. In an embodiment SASS values written as SASS(Aₐ|G_{g})represent a measure of association between purchase of item Aₐ subsequent to purchase of item G_{g}. SASS values written as SASS(G_{g}|Aₐ) represent a measure of association between purchase of item G_{g} subsequent to purchase of item Aₐ. SASS(Aₐ|G_{g})and SASS(G_{g}|Aₐ) may generically be written SASS(Aₐ,G_{g}) or SASS.

In an embodiment, processor 34 is operable to determine values for SASS based on at least one or any combination of more than one measure of statistical association. A measure of statistical association for which processor 34 determines values for SASS may be any of various measures of statistical association such as, by way of example, measures of support or confidence, an Odds Ratio (OR), Risk Ratio (RR), Absolute Risk Reduction (ARR), mutual information, a hypergeometric probability, and Lift. Processor 34 may comprise any electronic and/or optical processing circuitry known in the art, and may by way of example, comprise any one or any combination of more than one of a microprocessor, an application specific circuit (ASIC), field programmable array (FPGA), and/or system on a chip (SOC). In an embodiment, values for SASS determined by processor 34 are stored in memory 30.

In an embodiment, recommender watchman 36 comprises processing and/or control circuitry configured to generate and communicate recommendations to users 21 for purchase of items G_{g} and Aₐ based on values of SASS(G_{g},Aₐ). In an embodiment, recommender watchman 36 is configured to repeatedly access transactions database 32 to review data in the database and generate recommendations to users 21 based on what items they have purchased from one of catalogs X and W, what items they have not purchased from the other of the catalogs, and SASS values between items purchased and items not purchased. Optionally, recommender watchman 36 periodically accesses transactions database 32 to generate recommendations for users 21.

In an embodiment, DAS recommender system 20 comprises at least one monitoring agent schematically represent by a circle 23 that monitors access of users 21 to catalogs X and W and transmits transaction data based on access of users to the catalogs addressed to processor 34 for processing and storage in memory device 30 or addressed directly to memory device 30 for storage. Recommender watchman 36 may receive an alert from the at least one monitoring agent 23 when a user 21 accesses catalog X or catalog W. In response to the alert, recommender watchman 36 may generate a recommendation for the user based on items the user has purchased from catalog X and/or W and SASS values associated with the purchased items comprised in transactions database 32.

FIG. 2 shows a simplified flow diagram of a procedure 100 for which DAS recommender may determine, in accordance with an embodiment of the disclosure to recommend to a given user 21 a given item Aₐ*′ from among items Aₐ in catalog W if the given user has purchased items G_{g}* from among items G_{g} in catalog X.

In a block 101 DAS recommender system 20 receives data for user transactions with items G_{g} in catalog X and items Aₐ in catalog W and stores the transaction data in transactions database 32. Optionally, in a block 103 processor 34 processes the stored transaction data and determines SASS(G_{g},Aₐ) for catalog items in catalogs X and W. In a block 105, processor 34 may, optionally in response to a query from recommender watchman 36, determine which items G_{g}* given user 21 has purchased from among items G_{g} in catalog X and which items Aₐ* the user has not purchased from among items Aₐ in catalog W. Optionally, in a block 107, processor 34 determines for which pair of items G_{g}* and Aₐ*, SASS(Aₐ*|G_{g}*) is maximum. If in block 107 SASS(Aₐ*|G_{g}*) is found to be maximum for Aₐ*′, in a block 109, recommender watchman 36 may recommend item Aₐ*′ to given user 21. Whereas, in block 109 recommender watchman 36 recommends to given user 21 item Aₐ*′ for which SASS(Aₐ*|G_{g}*) is maximum, in an embodiment, the recommender watchman may, in addition, recommend to the given user items Aₐ* for which SASS(Aₐ*|G_{g}*) is relatively enhanced. For example, if SASS(Aₐ*|G_{g}*) is greater than at least one standard deviation from an expected value of SASS(Aₐ*|G_{g}*) assuming that that Aₐ* and G_{g}* are statistically uncorrelated.

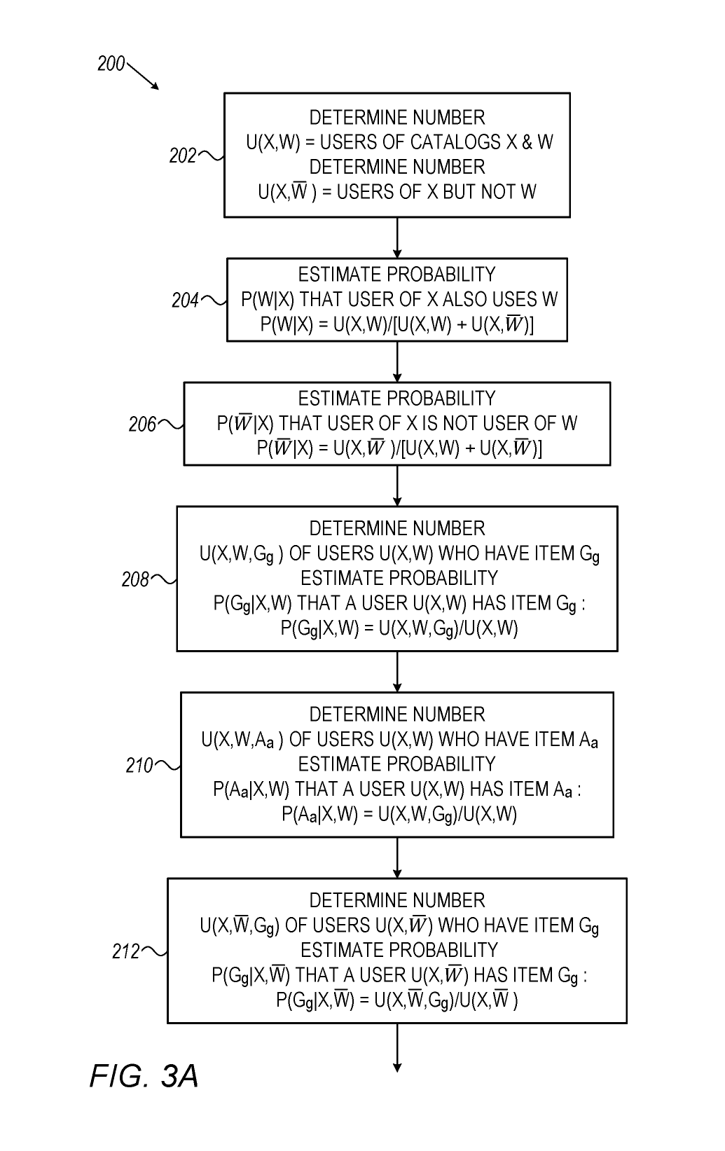

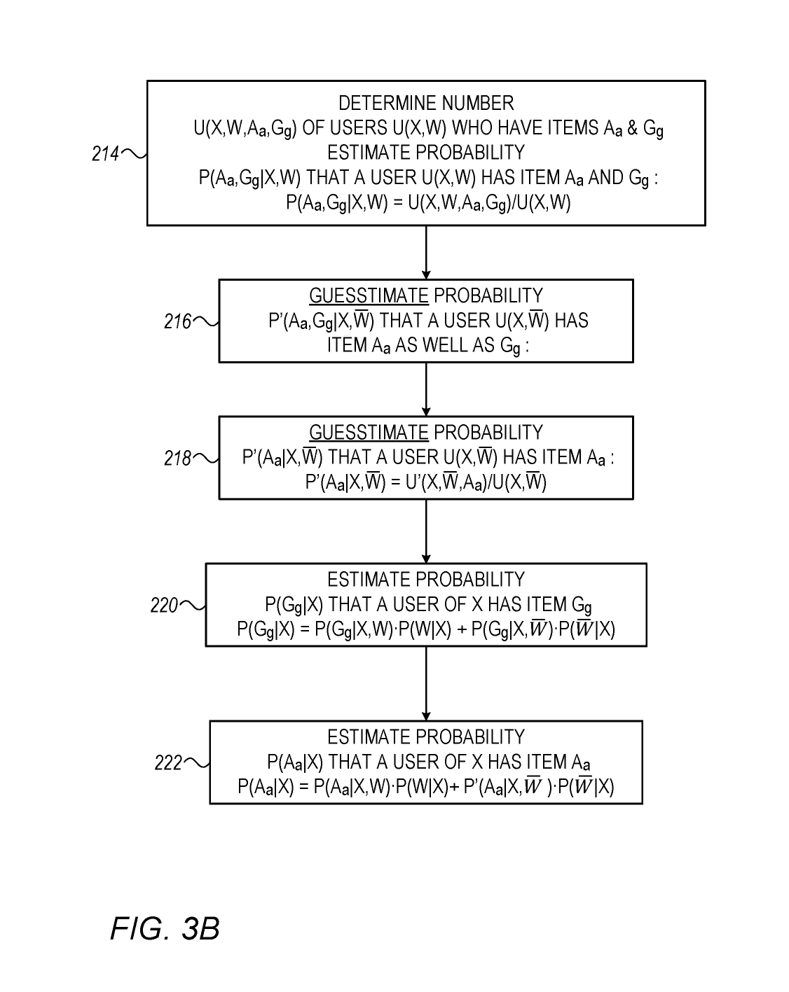

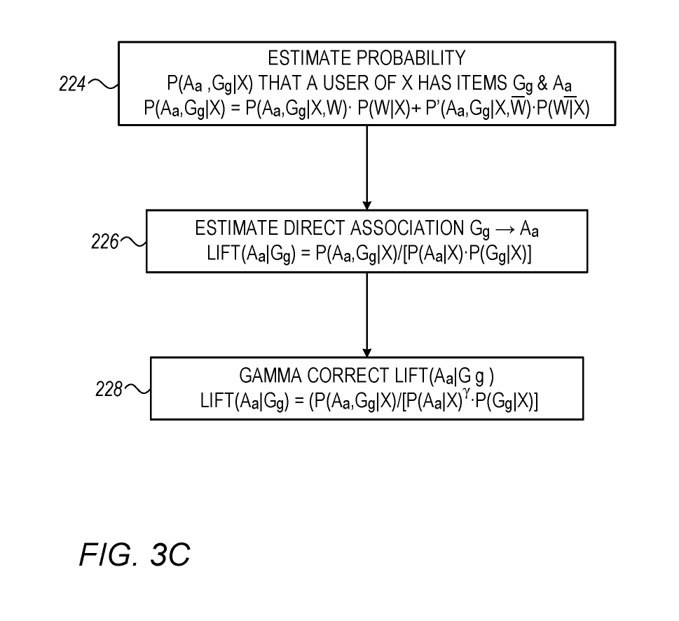

FIGS. 3A-3C show a flow diagram of a process 200 by which processor 34 determines values for SASS(Aₐ|G_{g}), in accordance with an embodiment of the disclosure.

In a block 202 processor 34 may determine a number, U(X,W), of users 21 for which transactions are stored in transactions database 32 that use both catalog X and catalog W, and a number U(X,W̅) of users 21 for which transactions are stored in transaction database 32 that use catalog X but not catalog W. In a block 204 processor 34 may estimate a probability P(W|X) that a user 21 of X also uses catalog W in accordance with an expression P(W|X)=U(X,W)/[U(X,W)+U(X,W̅)]. In a block 206 processor 34 may estimate a probability P(W|X) that a user 21 of X does not use catalog W in accordance with an expression P(W̅|X)=U(X,W̅)/[U(X,W)+U(X,W̅)].

In an embodiment, in a block 208 processor 34 determines a number, U(X,W,G_{g}), of users U(X,W) of both catalogs X and W who have purchased an item G_{g} and uses U(X,W,G_{g}) to estimate a probability P(G_{g}|X,W) that a user U(X,W) has purchased item G_{g} in accordance with an expression P(G_{g}|X,W) =U(X,W,G_{g})/U(X,W). Similarly, optionally in a block 210, processor 34 determines a number, U(X,W,Aₐ), of users U(X,W) of both catalogs X and W who have purchased an item Aₐ, and uses U(X,W, Aₐ) to estimate a probability P(Aₐ|X,W) that a user U(X,W) has purchased item Aₐ in accordance with an expression P(G_{g}|X,W)=U(X,W,G_{g})/U(X,W).

Optionally, in a block 212 processor 34 determines a number of users U(X,W̅,G_{g}) who use catalog X but not catalog W that have purchase item G_{g}, and use U(X,W̅,G_{g}) to estimate a probability P(G_{g}|X,W̅) that a user U(X,W̅) of catalog X but not W has purchased item G_{g} in accordance with an expression P(G_{g}|X,W̅)=U(X,W̅,G_{g})/U(X,W̅). And, in an embodiment, in a block 214 processor 34 determines a number U(X,W,Aₐ,G_{g}) of users U(X,W) who have purchased both items G_{g} and Aₐ and uses U(X,W,Aₐ,G_{g}) to estimate a probability P(Aₐ,G_{g}|X,W) that a user of both catalogs X and W has purchased both items G_{g} and Aₐ in accordance with an expression P(Aₐ,G_{g}|X,W)=U(X,W,Aₐ,G_{g})/U(X,W).

Whereas the various probabilities discussed above may be estimated from transaction data stored in transactions database 32, for certain probabilities that may be advantageous in determining SASS(Aₐ|G_{g}), data in transactions database 32 may be incomplete and the probabilities may not readily be determined from transactions data in the database. In an embodiment, data to complete incomplete data and is optionally “guesstimated” in blocks 216 and 218.

In block 216 processor 34 guesstimates a probability, P′(Aₐ,G_{g}|X,W̅), that a user U(X,W̅,) of catalog X but not catalog W who has purchased G_{g} from catalog X also purchases Aₐ, from a source other than catalog W. In an embodiment of the disclosure processor 34 may provide a value for P′(Aₐ,G_{g}|X,W̅) optionally in accordance with any of the following expressions.

P′(Aₐ,G_{g}|X,W̅)=P(Aₐ,G_{g}|X,W). 1)

P′(Aₐ,G_{g}|X,W̅)=P(Aₐ)·P(G_{g}|X), 2)

where P(Aₐ) is estimated as a fraction of the population of users of X and W who have purchased Aₐ. IF U(W) are the number of users of catalog W having transactions stored in database 32, then, optionally, P(Aₐ) =U(W,Aₐ)]/U(W)], where U(W,Aₐ) are the numbers of users of catalogs W who have purchased Aₐ.

P′(Aₐ,G_{g}|X,W̅)=1/A. 3)

The guesstimate assumes that a user of X but not W who has item G_{g} has an equal probability of having any one of the A items that are available from catalog W.

P′(Aₐ,G_{g}|X,W̅)=U(X,W,τ,Aₐ,G_{g})/U(X,W,τ) 4)

where U(X,W,τ) is a number of users of catalog X who have purchased have first started using catalog W within a last period of time “τ”. U(X,W,τ,Aₐ,G_{g}) is the number of users U(X,W,τ) who during the period τ who have item G_{g} and have purchased Aₐ from catalog W.

P′(Aₐ,G_{g}|X,W̅)=U(X,W,Aₐ1,G_{g})/U(X), 5)

where U(X,W Aₐ,1,G_{g}) represents a number of users of the total number of users U(X) whose first purchase from catalog W upon first using catalog W after using catalog X to purchase G_{g}, was Aₐ.

In block 218 processor 34 guesstimates a probability, P′(Aₐ|X,W̅), that a user U(X,W̅,) of catalog X but not catalog W has purchased Aₐ, from a source other than catalog W. In an embodiment of the disclosure processor 34 may provide a value for P′(Aₐ|X,W̅) optionally in accordance with any of the following expressions.

P′(Aₐ|X,W̅)=P(Aₐ|X,W). 6)

P′(Aₐ|X,W̅)=P(Aₐ|W), 7)

which estimates a probability that a user of X but not W having item Aₐ is equal to a probability P(Aₐ|W) that a user of catalog W has item Aₐ.

P′(Aₐ|X,W̅)=(1/A) 8)

The guesstimate assumes that a user of X but not W has an equal probability of having any one of the A items that are available from catalog W.

P′(Aₐ|X,W̅)=U(X,W,τ,Aₐ)/U(X,W,τ) 9)

where U(X,W,τ) are the number of users of catalog X who have started using catalog W for the first time within a last period of time “τ”, and U(X,W,τ,Aₐ) is the number of users U(X,W,τ) who have purchased Aₐ from catalog W.

P′(Aₐ|X,W)=U(X,W,Aₐ,1,G_{g})/U(X), 10)

where U(X,W,Aₐ,1,G_{g}) represents a number of users of the total number of users U(X) whose first purchase from catalog W upon first using catalog W after using catalog X to purchase G_{g}, was Aₐ.

Optionally, in a block 220 processor 34 estimates a probability P(G_{g}|X) that a user of X has purchased item G_{g} in accordance with an expression P(G_{g}|X)=P(G_{g}|X,W)·P(W|X)+P(G_{g}|X,W̅)·P(W|X). And, optionally in a block 222 processor 34 estimates a probability P(Aₐ|X) that a user of X has purchased item Aₐ in accordance with an expression P(Aₐ|X)=P(Aₐ|X,W)·P(W|X)+P′(Aₐ|X,W̅)·P(W|X). It is noted that whereas the estimate of the probability P(G_{g}|X) determined in block 220 does not rely on guestimates determined in blocks 216 and 218 the estimate of the probability P(Aₐ|X) uses the guestimate P′(Aₐ|X,W̅) determined in block 218. And optionally in a block 224, processor 34 uses the guestimate P′(Aₐ,G_{g}|X,W̅) determined in block 216 to estimate a probability P(Aₐ,G_{g}|X) that a user of X has purchased items G_{g} and Aₐ, in accordance with P(Aₐ,G_{g}|X)=P(Aₐ,G_{g}|X,W)·P(W|X)+P′(Aₐ,G_{g}|X,W̅)·P(W̅|X).

In an embodiment, processor 34, optionally in a block 226, determines a statistical association, SASS(Aₐ|G_{g}), between purchasing item Aₐ after having purchased item G_{g} as a value of a Lift function, LIFT(Aₐ|G_{g}) of Aₐ and G_{g}, where LIFT(Aₐ|G_{g})=P(Aₐ,G_{g}|X)/[P(Aₐ|X)·P(G_{g}|X)]. For circumstances in which a particular item Aₐ is very popular, change in value of LIFT(Aₐ|G_{g}) for change in P(Aₐ,G_{g}|X) may be reduced to a degree that obscures enhanced association of a given item Aₐ with respect to G_{g} relative to association between G_{g} to other items Aₐ in catalog W. Under such circumstances, to improve contrast between values of association for items Aₐ and G_{g} and improve recognition for enhanced associations, optionally in a block 228, processor 34 determines LIFT(Aₐ|G_{g}) in accordance with an expression LIFT(Aₐ|G_{g})=P(Aₐ,G_{g}|X)/[P(Aₐ|X)γ·P(G_{g}|X)] in which P(Aₐ|X) is raised to a power y. By way of example, γ may have a value greater than 1 and, optionally, less than or equal to 2, for situations in which a number of user transactions with Aₐ is greater than a sum of the numbers of user transactions for two of the most popular items other than Aₐ.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. Apparatus for recommending items from a catalog of items to users in a population of users, the method comprising:
a memory device having stored therein a transactions database comprising time resolved data characterizing user transactions with items from a first catalog and a second catalog;
a processor configured to process transaction data in the transactions database to determine values for a measure of statistical association between transactions of users with items in the first catalog and transactions of users with items in the second catalog;
at least one monitoring agent configured to monitor access of users to the first and second catalogs and generate an alert indicating a user access to a catalog of the first and second catalogs when a user accesses the catalog; and
a recommender watchman configured to communicate with the at least one monitoring agent via a communication network to receive the alert and based on the alert provide to the user for whom the alert was generated a recommendation based on the determined values of association.

2. The apparatus according to claim 1 wherein the processor is configured to determine the values for the measure of association based on transaction data in the memory device that is incomplete for the purpose of determining the values.

3. The apparatus according to claim 2 wherein the processor is configured to guesstimate data to complete the incomplete data for the purpose of determining the values for the measure of association.

4. The apparatus according to claim 1 wherein the time resolved transaction data comprises a transaction date for at least one transaction at which the at least one transaction was transacted.

5. The apparatus according to claim 1 wherein the time resolved transaction data comprises ordinal data for at least one transaction.

6. The apparatus according to claim 3 wherein the processor is configured to determine the value for the measure of association between a first item in the first catalog and a second item in the second catalog based on determining a guesstimate for a probability that a user who uses the first catalog but not the second catalog uses the first catalog to engage in a transaction with the first item and engages in a transaction with the second item without using the second catalog.

7. The apparatus according to claim 3 wherein the processor is configured to determine the value for the measure of association between a first item in the first catalog and a second item in the second catalog based on determining a guesstimate for a probability that a user who uses the first catalog but not the second catalog engages in a transaction with the item provided in the second catalog without using the second catalog.

8. The apparatus according to claim 1 wherein the measure of association between a user transaction with an item represented by G_{g} in the first catalog and a user transaction with an item represented by Aₐ in the second catalog is a LIFT function determined in accordance with an expression LIFT(Aₐ|G_{g})=P(Aₐ,G_{g}|X)/[P(Aₐ|X)·P(G_{g}|X)], where X represents the first catalog, P(Aₐ,G_{g}|X) is a probability that a user of X has engaged in transactions with G_{g} and Aₐ, P(Aₐ|X) is a probability that a user of the first catalog engages in a transaction with Aₐ, and P(G_{g}|X) is a probability that a user of the first catalog engages in a transaction with G_{g}.

9. The apparatus according to claim 1 wherein the measure of association between a user transaction with an item represented by G_{g} in the first catalog and a user transaction with an item represented by Aₐ in the second catalog is a LIFT function determined in accordance with an expression LIFT(Aₐ|G_{g})=P(Aₐ,G_{g}|X)/[P(Aₐ|X)γ·P(G_{g}|X)], where X represents the first catalog, P(Aₐ,G_{g}|X) is a probability that a user of X has engaged in transactions with G_{g} and Aₐ, P(Aₐ|X) is a probability that a user of the first catalog engages in a transaction with Aₐ, and P(G_{g}|X) is a probability that a user of the first catalog engages in a transaction with G_{g}, and γ is an exponent greater than 1.

10. A method of recommending an item from a catalog to a user, the method comprising:
determining for user transactions with each of at least one first item in a first catalog, for which of a plurality of second items in a second catalog user transactions exhibit enhanced statistical association based on data characterizing user transactions with the plurality of second items that is incomplete for the purpose of determining statistical associations between user transactions with the at least one first item and each of the plurality of second items; and
recommending the second item for which it is determined that user transactions exhibit enhanced association with user transactions with the at least one first item.

11. The method according to claim 10 and comprising guesstimating data to complete the incomplete data for the purpose of determining the statistical associations.

12. The method according to claim 11 wherein guesstimating data comprises guesstimating data based on time resolved transaction data for transactions with the plurality of second items.

13. The method according to claim 12 wherein the time resolved transaction data comprises transaction dates for user transactions with the second items.

14. The method according to claim 12 wherein the time resolved transaction data comprises ordinal data for user transactions with the second items.

15. The method according to claim 11 wherein guesstimating data comprises guesstimating a probability that a user who uses the first catalog but not the second catalog uses the first catalog to engage in a transaction with the at least one first item and engages in transactions with the plurality of second items without using the second catalog.

16. The method according to claim 11 wherein guesstimating data comprises guesstimating a probability that a user who uses the first catalog but not the second catalog engages in a transaction with the second items without using the second catalog.

17. The method according to claim 10 and comprising determining the statistical associations based on determining values of a LIFT function.

18. The method according to claim 17 and comprising determining a value for the LIFT function for user transactions between a first item of the at least one first item represented by G_{g} and a second item of the plurality of second items represented by Aₐ in accordance with an expression LIFT(Aₐ|G_{g})=P(Aₐ,G_{g}|X)/[P(Aₐ|X)·P(G_{g}|X)], where X represents the first catalog, P(Aₐ,G_{g}|X) is a probability that a user of X has engaged in transactions with G_{g} and Aₐ, P(Aₐ|X) is a probability that a user of the first catalog engages in a transaction with Aₐ, and P(G_{g}|X) is a probability that a user of the first catalog engages in a transaction with G_{g}.

19. The method according to claim 17 wherein the LIFT function is determined in accordance with an expression LIFT(Aₐ|G_{g})=P(Aₐ,G_{g}|X)/[P(Aₐ|X)γ·P(G_{g}|X)], where X represents the first catalog, P(Aₐ,G_{g}|X) is a probability that a user of X has engaged in transactions with G_{g} and Aₐ, P(Aₐ|X) is a probability that a user of the first catalog engages in a transaction with Aₐ, and P(G_{g}|X) is a probability that a user of the first catalog engages in a transaction with G_{g}, and γ is an exponent greater than 1.
